(19) United States
(12) Patent Application Publication
(10) Pub. No.: US 2020/0063019 A1
(43) Pub. Date: Feb. 27, 2020

(54) ULTRASONIC SOLUBILISATION OF SURFACTANTS FOR ENHANCED OIL RECOVERY

(71) Applicant: RHODIA OPERATIONS, Paris (FR)

(72) Inventors: Pascal HERVE, Talence (FR); Cyril VIDAILLAC, VILLENAVE D'ORNON (FR); Nicolas WARTENBERG, Bordeaux (FR)

(21) Appl. No.: 16/611,112

(22) PCT Filed: May 3, 2018
(86) PCT No.: PCT/EP2018/061300

§ 371 Date: Nov. 5, 2019

(30) Foreign Application Priority Data
May 5, 2017 (FR) 1753964

(51) Int. Cl. C09K 8/584; E21B 43/16

(52) U.S. Cl. CPC C09K 8/584; E21B 43/162

(57) ABSTRACT

The invention concerns the solubilisation of surfactants suitable for enhanced oil recovery within an aqueous medium, by mixing said surfactants and the aqueous medium, carried out under ultrasound, advantageously to provide an over-concentrated solution that can be re-diluted with water available at the extraction site without impacting on the salinity of same. The invention also concerns the extraction fluids obtained according to this solubilisation technique and the use of same in EOR.

The present invention relates to surfactants used for the enhanced recovery of crude oil from underground formations, and more particularly to the problems of dissolution of these surfactants in the injection fluids used during steps of enhanced oil recovery.

During the extraction of oil from a hydrocarbon reservoir (oil-yielding reservoir such as a consolidated or non-consolidated rock formation, or a sand, for example), according to a first step known as “primary recovery”, the oil is entrained out of a production well by the excess pressure naturally prevailing in the reservoir. This primary recovery gives access to only a small amount of the oil contained in the reservoir, typically at the very most about 10% to 15%.

In order to enable the extraction of the oil to continue after this primary recovery, secondary production methods are employed, when the pressure in the reservoir becomes insufficient to displace the oil that is still in place. Typically, a fluid is injected (reinjection of the water produced, either diluted or not, injection of sea water or river water, or injection of gas, for example) into the hydrocarbon reservoir in order to produce in the reservoir an overpressure suitable for entraining the oil toward the production well(s). A usual technique in this context is injection of water (also known as inundation or waterflooding), in which large volumes of water are injected under pressure into the reservoir via injection wells. The injected water entrains part of the oil that it encounters and pushes it toward one or more production wells. However, secondary production methods such as waterflooding make it possible to extract only a relatively small part of the hydrocarbons in place (typically about 30%). This partial flushing is due especially to the trapping of the oil by the capillary forces, to the differences in viscosity and density existing between the injected fluid and the hydrocarbons in place, and also to heterogeneities at microscopic or macroscopic scales (at the scale of the pores and also at the scale of the reservoir).

In an attempt to recover the rest of the oil, which remains in the subterranean formations after implementation of primary and secondary production methods, various techniques have been proposed, referred to as “enhanced oil recovery”, abbreviated as EOR (or enhanced (or improved) hydrocarbon recovery, EHR). Among these techniques, mention may be made of techniques similar to the abovementioned waterflooding (inundation), but using a water comprising additives, for instance water-soluble surfactants (this is then typically referred to as surfactant flooding). The use of such surfactants notably induces a decrease in the water/oil interface tension, which is capable of ensuring more efficient entrainment of the oil trapped in the pore constrictions.

The surfactants usually recommended for EOR are typically anionic surfactants, generally of sulfate or sulfonate type. These surfactants, which prove to be effective for lowering the water/oil interface tension, have the drawback of being difficult to dissolve in the injection fluids employed in EOR, most particularly when said fluids comprise salts, which is quite often the case. In particular, it often proves difficult to dissolve them in the water available in proximity to drilling areas, notably in seawater or production water.

To allow efficient dissolution of the anionic surfactants used in EOR, one recommended technique consists in using them as a mixture with large amounts of cosolvent (notably an alcohol or a mixture of alcohols) chosen, for example, from the following: sec-butanol, n-butanol, diethylene butyl ether. The use of this type of cosolvent facilitates the dissolution, but most of the time the dissolution requires the additional use of high-shear mixers and/or of heating means and/or of water of low salinity, which emburdens the process and notably has repercussions in terms of increased production costs.

One aim of the present invention is to provide a technique for the efficient dissolution of the surfactants employed in EOR, which is more practical and which makes it possible, among other advantages, to dispense with the abovementioned use of cosolvents.

To this end, it is proposed according to the present invention to perform the dissolution of the surfactants by subjecting them to ultrasound.

More precisely, one subject of the present invention is a process for dissolving surfactants that are suitable for enhanced oil recovery in an aqueous medium, which comprises a step (E1) of mixing said surfactants and the aqueous medium, performed with ultrasound.

Step (E1) of ultrasound-mediated mixing of the invention enables, if need be, the dissolution of the surfactants to very high concentrations (typically at least 100 g/L, or even at least 150 g/L), which are much higher than the concentrations required in an extraction fluid. Given this possibility, according to a very advantageous embodiment, the ultrasound-mediated mixing technique of the invention can be performed to prepare a superconcentrated solution in which the surfactant is dissolved, and this superconcentrated solution is subsequently diluted to produce an extraction fluid (typically by mixing this superconcentrated solution with water available at the extraction site, optionally, but not necessarily, with additives, for instance polymers).

Thus, according to an advantageous embodiment, the process includes at least the following two steps:
the abovementioned mixing step (E1), performed with a first aqueous medium to prepare an aqueous solution of surfactants, referred to as solution (s) (having a concentration higher than that desired in the dissolution process); and then
a dilution step (E2) in which solution (s) obtained from the mixing step (E1) is mixed with a second aqueous medium, identical to or different from the aqueous medium employed in step (E1).

This embodiment, which proceeds via the preparation of a superconcentrated solution, has the advantage of reducing the volume to be treated with ultrasound and thus the dimensioning and cost of the process.

Moreover, it allows very easy manufacture of an extraction fluid on site from the superconcentrated solution. In step (E2), the dilution is performed very easily, by simple mixing, without the need to take the salinity of the available water into account (it is thus possible to use very saline waters such as seawater or production water) and without the need to resort to a cosolvent, a heating step or a specific stirring technique.

Since the injection concentration typically targeted in EOR is between 1 and 8 g/L, the concentration of solution (s) is advantageously greater than 10 g/L, for example between 50 and 150 g/L, notably between 100 and 150 g/L.

The dissolution process of the invention thus proves to be most particularly suitable for dissolving surfactants in aqueous media comprising salts, notably the injection brines typically employed in EOR, irrespective of their degree of salinity.

Typically, the mixing step (E1) is performed in the absence of any cosolvent. When a dilution step (E2) is performed, this step does not require the use of cosolvents either, which leads to novel surfactant solutions. According to another particular aspect, a subject of the present invention is these novel aqueous solutions (including the abovementioned superconcentrated solutions and the extraction fluids) of the type obtained according to the ultrasound-mediated dissolution process of the invention, which comprise surfactants that are suitable for enhanced oil recovery in an aqueous medium and which are free of cosolvents.

These aqueous solutions generally contain surfactants in a proportion of at least 1 g/L, typically between 1 and 8 g/L for extraction fluids; or between 10 and 150 g/L, more often between 50 and 150 g/L, typically between 100 and 150 g/L as regards superconcentrated solutions. Moreover, in general, they do not contain any cosolvents such as alcohols. In particular, these aqueous solutions do not need to contain alcohols which aid the dissolution of the surfactants, for instance sec-butanol, n-butanol, or else diethylene butyl ether. Needless to say, the dispersion can be performed in the presence of alcohols according to certain very particular embodiments. However, insofar as they are unnecessary, it is preferred to avoid using them, notably for cost reasons.

According to yet another aspect, a subject of the present invention is a process of enhanced oil recovery from an underground formation, in which:
a fluid comprising an aqueous medium and an anionic surfactant is injected into said underground formation, via at least one injection well, said fluid being derived from an ultrasound-mediated mixing of said surfactants and of the aqueous medium (this fluid typically being one of the novel injection fluids described in the preceding paragraphs); and
a fluid conveying the oil leaving the underground formation is recovered via at least one production well.

In the context of the studies which led to the present invention, the inventors have now demonstrated that, despite the difficulties that were observed in the past for dissolving the surfactants employed for EOR (and most particularly the abovementioned anionic surfactants of sulfate and sulfonate type), it in fact proves to be possible to dissolve these surfactants at high concentrations merely by the effect of applying ultrasound, without the need to use the cosolvents generally required to do so. Needless to say, ultrasound-mediated dissolution is possible in the presence of cosolvents, but their presence is not in any way required to obtain the dissolution effect according to the invention, which constitutes a major advantage notably in terms of costs. This advantage is particularly surprising, insofar as the dissolution of the surfactants employed for EOR (most particularly in injection brines) is difficult, if not impossible, with other dispersion means, notably with high-shear mixers of rotor/stator type even in the presence of cosolvents.

The ultrasound-mediated dissolution of the present invention proves to be particularly suitable for implementation on an oil extraction zone. In particular, it allows the use of water which may have a high salinity for the dissolution. Thus, in the process of the invention, use may notably be made of a water available in proximity to the extraction zone (for example seawater) without having to pretreat this water to reduce the salinity thereof. More generally, the process of the invention allows the dissolution of surfactants for EOR in the majority of the injection brines typically employed in EOR techniques.

In addition, the process of the invention does not require the use of heating means, which constitutes another economic advantage. Thus, typically, the process of the invention is performed at room temperature, by simply introducing the aqueous medium and the surfactants to be dissolved in an ultrasound mixer.

The ultrasound-mediated mixing that is performed in the context of the present invention, also known as sonication, may be performed via any means known per se. For the purposes of the present description, the term “ultrasound-mediated” mixing denotes mixing performed by applying mechanical waves (known as sound waves, although they are inaudible) with a frequency of greater than 10 kHz, typically between 15 kHz and 500 MHz, for example between 20 kHz and 10 MHz. Ultrasound-mediated mixing is a technique that is well known per se, which may be described, for example, in KREMER Daniel, 1998 Usinage par ultrasons, Techniques de l'ingénieur Procédés d'usinage [Ultrasound-mediated tooling, Engineering techniques, machining processes] and PÉTRIER Christian et al., 2008 Ultrasons et sonochimie, Techniques de l'ingénieur Optimisation des modes de séparation, d'activation, de synthèse et d'analyse [Ultrasonication and sonochemistry, Engineering techniques, Optimization of separation, activation, synthetic and analytical methods],

In the context of the present invention, ultrasound-mediated mixing may be performed under the most common conditions, the mixing being in general all the more efficient the higher the intensity and frequency of the ultrasound. The intensity of the ultrasound according to the invention is preferably applied with an intensity and for a time corresponding to a delivered energy of greater than 5 Wh/L, preferably of at least 10 Wh/L, for example between 15 and 30 Wh/L.

The ultrasound-mediated dissolution process of the present invention proves to be most particularly suitable for the anionic surfactants that are useful for EOR. For the purposes of the present invention, the notion “anionic surfactant” encompasses surfactants suitable for EOR and bearing at least one anionic group under the conditions of the extraction performed. The invention proves to be notably suitable for the dissolution of anionic surfactants of sulfate and/or sulfonate type, and notably surfactants chosen from:
olefin sulfonates (notably internal olefin sulfonates);
alkylarylsulfonates, for instance alkylbenzene sulfonates;
alkyl ether sulfates;
alkyl glyceryl ether sulfonates (AGES); and
mixtures of these surfactants.

The process of the invention makes it possible to dissolve the surfactants of the abovementioned type at high concentrations in an aqueous medium, typically greater than 100 g/L, or even 150 g/L in certain cases. Typically, the ultrasound-mediated dissolution process of the invention makes it possible to obtain an aqueous medium comprising the surfactants at a concentration of between 1 and 150 g/L.

The process of the invention makes it possible to dissolve the abovementioned surfactants in the majority of aqueous media. The process of the invention proves to be most particularly advantageous for dissolving the surfactants in a saline aqueous medium, typically comprising up to 150 g/L of salts.

When the surfactants of the present invention are used together with polymers, the ultrasound-mediated surfactant dissolution step is preferably performed before introducing the polymers, which are subsequently dispersed into the aqueous medium without the polymers being subjected to ultrasound, otherwise the ultrasound might degrade the polymers. According to an alternative embodiment which is suitable in certain particular cases, the sonication may be performed in the presence of all or a portion of the polymers, for example in the particular case of polymers that are not too sensitive to ultrasound or else polymers for which degradation is acceptable.

The example given below illustrates a nonlimiting embodiment of the invention and some of the advantages thereof.

### EXAMPLE

In this example, ultrasound-mediated dissolution according to the invention was performed on a mixture containing the following surfactants:
21% by mass of alkylbenzene sulfonate Surf EOR ASP 4201
24% by mass of alkyl glyceryl ether sulfonate Surf EOR ASP 1580
   150 g of this mixture were dissolved at room temperature (25° C.) in 1 liter of aqueous medium (m) containing:
15.7 g of NaCl
0.12 g of KCl
0.14 g of MgCl2.6H20
0.12 g of CaCl2.6H20
   by subjecting the mixture to ultrasound (sonication) using a Branson Digital Sonifier S-450 ultrasound machine delivering a power of 75 W for 30 seconds with stirring. The surfactants are fully dissolved in the water on conclusion of the sonication, giving a clear solution, without the need to heat or to add cosolvent.

The solution obtained was then diluted by simple mechanical stirring in the aqueous medium (m) defined above, to a concentration of 0.5 g/L, giving a clear solution.

For comparative purposes, the table below indicates the conditions to be implemented to dissolve the mixture without employing the method of the invention, which illustrates the need to employ a cosolvent (diethylene glycol butyl ether DGBE is illustrated here) in amounts that are even greater if no heating is performed or if the surfactants are not pre-diluted in non-saline water.

| | Predilution of the | |
|---|---|---|
| heating | surfactants (*) | Amount of DGBE to be added (**) |
| 80° C. | yes | 17% |
| no | yes | 25% |
| no | no | 46% |

(*): with non-saline water (15% of the volume of the solution)
(**): in mass percentage, relative to the mass of the surfactants

Moreover, the reduction in turbidity which can be obtained by sonication was compared with the use of a high-shear mixer. The table below shows the change in turbidity measured using an AQ3010 turbidimeter (Fisher Scientific) as a function of the energy applied expressed in Wh/L.

| | |
|---|---|
| Ultrasound | High-shear mixer |

| Wh/L | Turbidity (NTU) | Wh/L | Turbidity (NTU) |
|---|---|---|---|
| 0.0 | 1000 | 0.0 | 1000 |
| 4.2 | 780 | 2.5 | 759 |
| 8.6 | 232 | 6.3 | 624 |
| 13.4 | 83.9 | 12.5 | 522 |
| 18.8 | 62.7 | 18.8 | 470 |
| 24.7 | 58.8 | 25.0 | 439 |
| | | 31.3 | 418 |
| | | 37.5 | 400 |
| | | 43.8 | 391 |
| | | 50.0 | 382 |
| | | 56.3 | 377 |
| | | 62.5 | 370 |
| | | 68.8 | 363 |

This table clearly illustrates the fact that a high-shear mixer makes it possible at best to achieve values of the order of 400 NTU by applying substantial energy, whereas sonication makes it possible to achieve, at much lower energy values, a turbidity of less than 200 NTU, which corresponds to the turbidity range desired to ensure good efficiency of the surfactants in EOR.

1. A process for dissolving surfactants that are suitable for enhanced oil recovery in an aqueous medium, which comprises a step (E1) of mixing said surfactants and the aqueous medium, performed with ultrasound.

2. The dissolution process as claimed in claim 1, which comprises the following steps:
step (E1) of mixing said surfactants and the aqueous medium, performed with ultrasound, via which an aqueous solution is prepared, known as solution (s); and then
a dilution step (E2) in which solution (s) obtained from the mixing step (E1) is mixed with an aqueous medium identical to or different from the aqueous medium employed in step (E1).

3. The dissolution process as claimed in claim 1, wherein the mixing step (E1) is performed in the absence of any cosolvent.

4. The process as claimed in claim 1, wherein the surfactants are anionic surfactants.

5. The process as claimed in claim 4, wherein the surfactants are selected from the group consisting of:
olefin sulfonates;
alkylarylsulfonates;
alkyl ether sulfates;
alkyl glyceryl ether sulfonates; and
mixtures of these surfactants.

6. An aqueous solution of surfactants that are suitable for enhanced oil recovery, obtained according to the process of claim 1, said solution not containing any alcohol.

7. A process of enhanced oil recovery from an underground formation involving the use of an aqueous solution obtained according to the process of claim 1, in which:
injecting a fluid comprising an aqueous medium and an anionic surfactant into said underground formation, via at least one injection well, said fluid being derived from mixing of said surfactants and of the aqueous medium according to the process of claim 1; and
recovering a fluid conveying the oil leaving the underground formation via at least one production well.

8. The enhanced oil recovery process as claimed in claim 7, wherein the injected fluid does not contain any alcohol.
